(19) United States
(12) Patent Application Publication
(10) Pub. No.: US 2014/0085874 A1
(43) Pub. Date: Mar. 27, 2014

(54) LUMINAIRE

(71) Applicant: Toshiba Lighting & Technology Corporation, Kanagawa (JP)

(72) Inventors: Makoto KAWAGOE, Kanagawa (JP); Yoko NOGUCHI, Kanagawa (JP); Takayuki ONO, Kanagawa (JP)

(21) Appl. No.: 13/921,638

(22) Filed: Jun. 19, 2013

(30) Foreign Application Priority Data
Sep. 21, 2012 (JP) 2012-208696

(51) Int. Cl. F21S 8/04; F21V 5/00

(52) U.S. Cl. CPC F21S 8/04; F21V 5/00
USPC 362/147; 362/311.01; 362/311.03; 362/311.06; 362/311.15

(57) ABSTRACT

A luminaire includes a light-emitting element, a side surface cover, a lower surface cover, a diffuser, and a prism, which is an example of an optical member. The light-emitting element emits light. The side surface cover is arranged a predetermined distance from the light-emitting element. The light emitted by the light-emitting element is transmitted through the side surface cover. The lower surface cover is provided at the lower end of the side surface cover. The light emitted by the light-emitting element is transmitted through the lower surface cover. The diffuser is a member provided between the lower surface cover and the light-emitting element to diffuse the light emitted by the light-emitting element. The prism adjusts a traveling direction of the light transmitted through the side surface cover to be different from a traveling direction of the light emitted by the light-emitting element and transmitted through the lower surface cover.

### CROSS-REFERENCE TO RELATED APPLICATIONS

This application is based upon and claims the benefit of priority from Japanese Patent Application No. 2012-208696 filed on Sep. 21, 2012, the entire contents of which are incorporated herein by reference.

### FIELD

Embodiments described herein relate generally to a luminaire.

### BACKGROUND

A luminaire including semiconductor light-emitting elements such as LEDs (Light Emitting Diodes) as light sources is used. As an example of such a luminaire, there is a luminaire in which a diffuser is proved at the lower ends of side surface covers.

However, in such a luminaire, light is diffused to a wide area by the diffuser of the luminaire. Therefore, for a person located in a wide area of a room where the luminaire is set, the light from the luminaire is glaring.

Even if the light emitted from the luminaire is glaring, if a luminaire that emits less bright light is provided in the room, a sense of brightness decreases for the person in the room.

### BRIEF DESCRIPTION OF THE DRAWINGS

FIG. 1 is a perspective view of an external appearance example of a luminaire according to an embodiment;

FIG. 2 is a sectional view of the luminaire shown in FIG. 1;

FIG. 3 is a diagram of an external appearance example of a diffuser;

FIG. 4 is a diagram of an external appearance example of a light-emitting module;

FIG. 5 is a sectional view of a portion covered with a lower surface cover on the left side in FIG. 1;

FIG. 6 is a diagram of an example of a positional relation between the diffuser and the lower surface cover;

FIG. 7 is a diagram for explaining an example of an effect of the luminaire according to the embodiment; and

FIG. 8 is a diagram for explaining an example of an effect of the luminaire according to the embodiment.

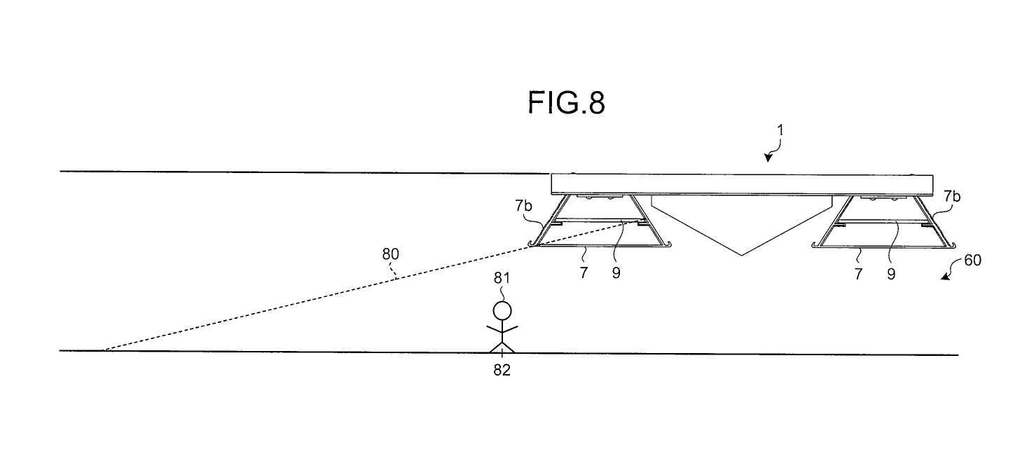

### DETAILED DESCRIPTION

A luminaire 1 according to an embodiment explained below includes a light-emitting element 12, a side surface cover 6, a lower surface cover 7, a diffuser 9, and a prism 7b, which is an example of an optical member. The light-emitting element 12 emits light. The side surface cover 6 is arranged a predetermined distance from the light-emitting element 12. The light emitted by the light-emitting element 12 is transmitted through the side surface cover 6. The lower surface cover 7 is provided at the lower end of the side surface cover 6. The light emitted by the light-emitting element 12 is transmitted through the lower surface cover 7. The diffuser 9 is a member provided between the lower surface cover 7 and the light-emitting element 12 to diffuse the light emitted by the light-emitting element. The prism 7b adjusts a traveling direction of the light transmitted through the side surface cover 6 to be different from a traveling direction of the light emitted by the light-emitting element 12 and transmitted through the lower surface cover 7.

In the luminaire 1 according to an embodiment explained below, an angle formed by a straight line 80, which connects a lower end 6b of the side surface cover 6 and a point 9b on the diffuser 9 most distant from the lower end 6b of the side surface cover 6, and a direction 9a perpendicular to a planar shape of the diffuser 9 is an angle equal to or larger than 5 degrees and equal to or smaller than 30 degrees.

In the luminaire 1 according to the embodiment explained below, the light diffused or reflected by the diffuser 9 is transmitted through the side surface cover 6.

The luminaire 1 according to the embodiment explained below further includes an attachment member 2 for attaching the luminaire 1 to the ceiling. In the luminaire 1, the prism 7b adjusts the traveling direction of the light transmitted through the side surface cover 6 such that the light transmitted through the side surface cover 6 is irradiated on the ceiling.

In the luminaire 1 according to the embodiment explained below, the prism 7b adjusts the traveling direction of the light transmitted through the side surface cover 6 such that the light is irradiated on the ceiling in a traveling direction at an angle equal to or larger than 40 degrees and equal to or smaller than 90 degrees with respect to a direction perpendicular to the ceiling.

In the luminaire 1 according to the embodiment explained below, a refractive index of the prism 7b is equal to or larger than 1.45 and equal to or smaller than 1.65.

In the luminaire 1 according to the embodiment explained below, a ratio of an amount of the light transmitted through the lower surface cover 7 and an amount of the light adjusted by the prism 7b is in a range of 1:9 to 2:8.

In the luminaire 1 according to the embodiment explained below, a hollow 6a is formed in a part of the side surface cover 6. In the luminaire 1, a protrusion 7c on the prism 7b is configured to fit in the hollow 6a by which the prism 7b to be attached to the side surface cover 6.

In the luminaire 1 according to the embodiment explained below, the lower surface cover 7 and the prism 7b are integrally molded.

In the luminaire 1 according to the embodiment explained below, the side surface cover 6 and the prism 7b may be integrally molded.

In the luminaire 1 according to the embodiment explained below, the side surface cover 6, the lower surface cover 7, and the prism 7b may be integrally molded.

In the luminaire 1 according to the embodiment explained below, the lower surface cover 7, the side surface cover 6, the prism 7b, and the diffuser 9 may be integrally molded.

In the luminaire 1 according to the embodiment explained below, the luminaire 1 includes a plurality of the side surface covers 6 and the prism 7b is provided on the side surface cover 6 that is located on the outermost side among the plurality of side surface covers 6.

In the luminaire 1 according to the embodiment explained below, the prism 7b may be provided in each of the plurality of side surface covers 6.

In the luminaire 1 according to the embodiment explained below, the prism is formed of a material containing acrylic resin or polycarbonate resin.

### External Appearance Example of the Luminaire

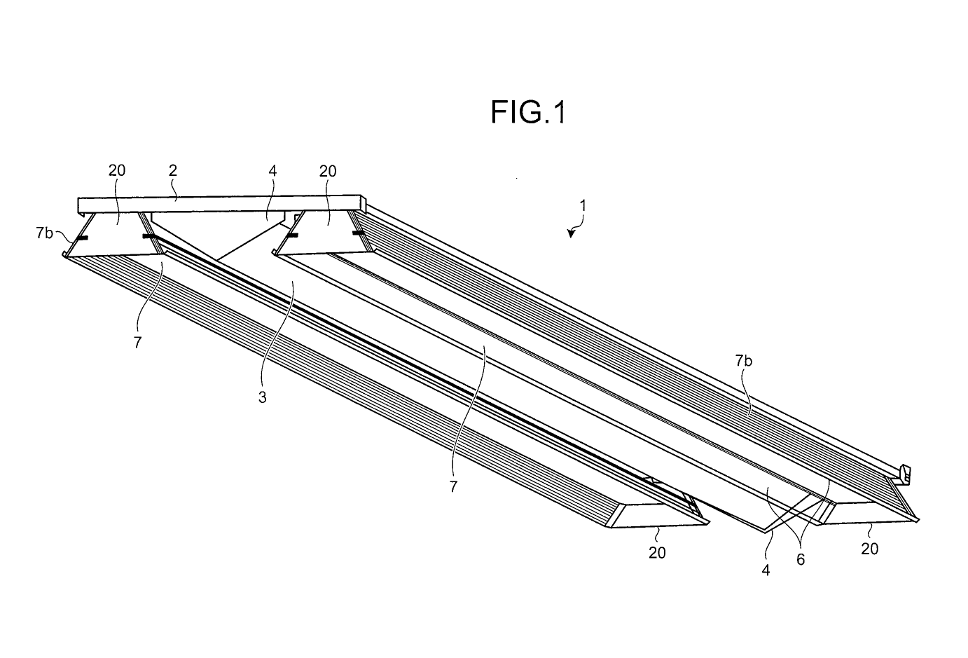

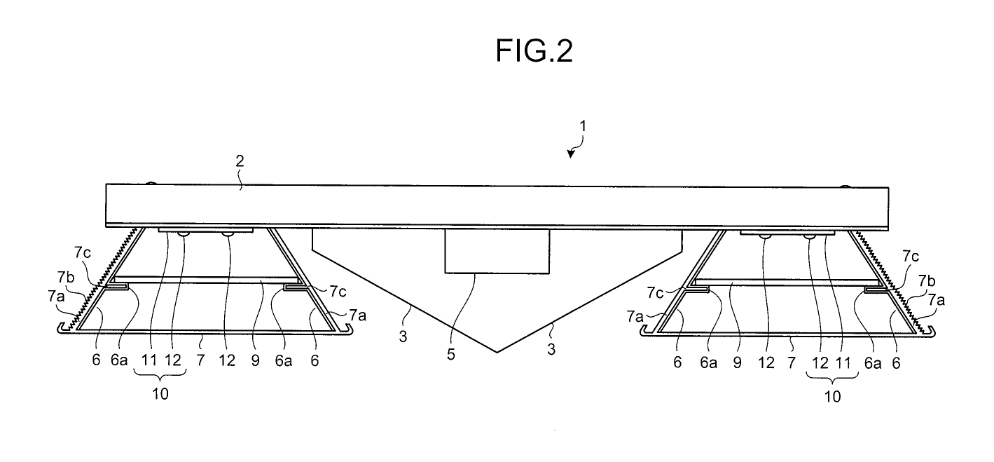

The luminaire according to the embodiment is explained below with reference to the drawings. FIG. 1 is a perspective view of an external appearance example of the luminaire 1 according to the embodiment. FIG. 2 is a sectional view of the luminaire shown in FIG. 1. In FIGS. 1 and 2, reference numeral 1 denotes a luminaire fixture for the ceiling or the like.

The luminaire 1 shown in FIGS. 1 and 2 is, for example, a luminaire set on an indoor ceiling. The luminaire 1 shown in FIGS. 1 and 2 lights the downward direction and the upward direction shown in FIGS. 1 and 2 by causing, for example, a light-emitting element such as an LED to emit light. For example, the luminaire 1 lights the floor and the ceiling in the room. The luminaire 1 includes the attachment member 2, a reflector 3, end plates 4, the side surface covers 6, and the lower surface cover 7.

For example, the attachment member 2 is attached to the indoor ceiling using a plurality of screws not shown in the figure. Consequently, the luminaire 1 is attached and fixed to the ceiling.

The reflector 3 is formed of, for example, a synthetic resin such as ABS resin or metal such as aluminum die-cast. The reflector 3 is a member configured to reflect lights emitted by the light-emitting elements 12 explained below and transmitted by the side surface covers 6 and side surface sections 7a. For example, the reflector 3 reflects the lights toward the floor direction in the room.

A lighting circuit 5 is provided in a space formed by the reflector 3, the end plates 4, and the attachment member 2. The lighting circuit 5 receives a commercial alternating-current power supply, generates a direct-current output, and supplies the direct-current output to the light-emitting elements 12 of a light-emitting module 10 explained below.

The side surface covers 6 are members formed of a material containing acrylic resin or polycarbonate resin and configured to transmit the lights emitted by the light-emitting elements 12 and lights diffused or reflected by the diffuser 9 explained below. The hollows 6a in which the protrusions 7c explained below are fit are formed in the side surface covers 6. The diffuser 9 is attached to the hollows 6a. As shown in FIG. 2, the side surface covers 6 are arranged a predetermined space apart from the light-emitting elements 12.

The lower surface cover 7 is a member formed of a material containing acrylic resin or polycarbonate resin and configured to transmit the lights diffused by the diffuser 9 among the lights emitted by the light-emitting elements 12. As shown in FIG. 2, the lower surface cover 7 is formed to cover the side surface covers 6 and is attached to the attachment member 2. The lower surface cover 7 includes the side surface sections 7a configured to cover the side surface covers 6. Since the side surface sections 7a transmit lights, the lights transmitted through the side surface covers 6 are transmitted through the side surface sections 7a as well. That is, the side surface sections 7a transmit the lights emitted by the light-emitting elements and transmitted through the side surface covers 6 and the lights diffused or reflected by the diffuser.

The plurality of prisms 7b are integrally molded with the lower surface cover 7 and the side surface sections 7a and provided in the side surface sections 7a that cover the side surface cover 6 located at the very end, i.e., the side surface cover 6 located on the outermost side among the plurality of side surface covers 6. The prisms 7b are optical members for refracting the lights transmitted through the side surface covers 6 and the side surface sections 7a such that traveling directions of the lights transmitted through the side surface covers 6 and the side surface sections 7a are directions different from traveling directions of the light transmitted through the lower surface cover 7. That is, the prisms 7b adjust traveling directions of the lights transmitted through the side surface covers 6 and the side surface sections 7a to be different from the traveling directions of the lights transmitted through the lower surface cover 7. Specifically, when the luminaire 1 is attached to the ceiling, the prisms 7b adjust the traveling directions of the lights transmitted through the side surface covers 6 and the side surface sections 7a such that the lights transmitted through the side surface covers 6 and the side surface sections 7a are irradiated on the ceiling. The prisms 7b are explained below. The plurality of prisms 7b may be respectively provided in all of the plurality of side surface covers 6. In this case, the lights from the prisms 7b adjacent to the reflector 3 travel toward the reflector 3. Therefore, a larger amount of the lights travel toward the reflector 3. Therefore, it is possible to further improve a sense of brightness of a space and provide a more comfortable lighting space for a person.

The protrusions 7c are formed in the side surface sections 7a. The protrusions 7c are fit in the hollows 6a explained above, whereby the side surface covers 6 are attached to the lower surface cover 7. Not limited thereto, the side surface sections 7a and the prisms 7b and the side surface covers 6 may be integrally molded. The lower surface cover 7, the side surface sections 7a and the prisms 7b, and the side surface covers 6 may be integrally molded. The lower surface cover 7, the side surface sections 7a and the prisms 7b, the side surface covers 6, and the diffuser 9 may be integrally molded.

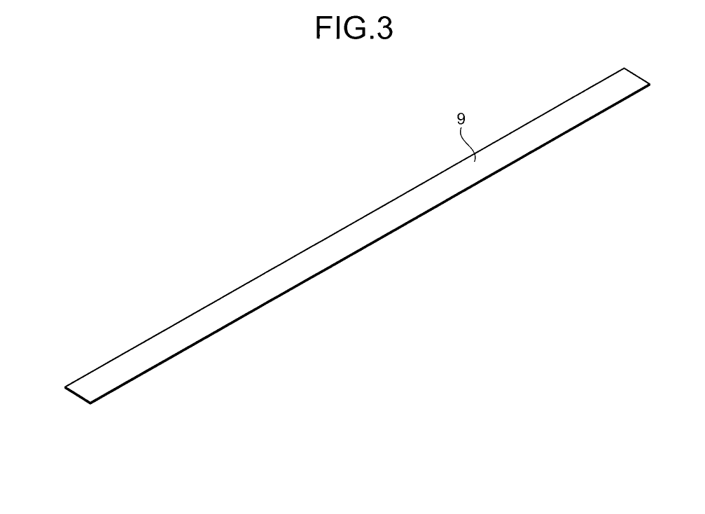

The diffuser 9 is formed of a material containing polycarbonate resin or acrylic resin mixed with a diffusing material for diffusing light. As shown in FIG. 2, the diffuser 9 is provided in a space formed by the lower surface cover 7 and the attachment member 2. FIG. 3 is a diagram of an external appearance example of the diffuser 9. As shown in an example in FIG. 2, the diffuser 9 shown in an example in FIG. 3 is attached to the hollows 6a. That is, the diffuser 9 is a member provided between the lower surface cover 7 and the light-emitting elements 12 and configured to diffuse lights emitted from the light-emitting elements 12. Further, the diffuser 9 reflects a part of the lights emitted from the light-emitting elements 12.

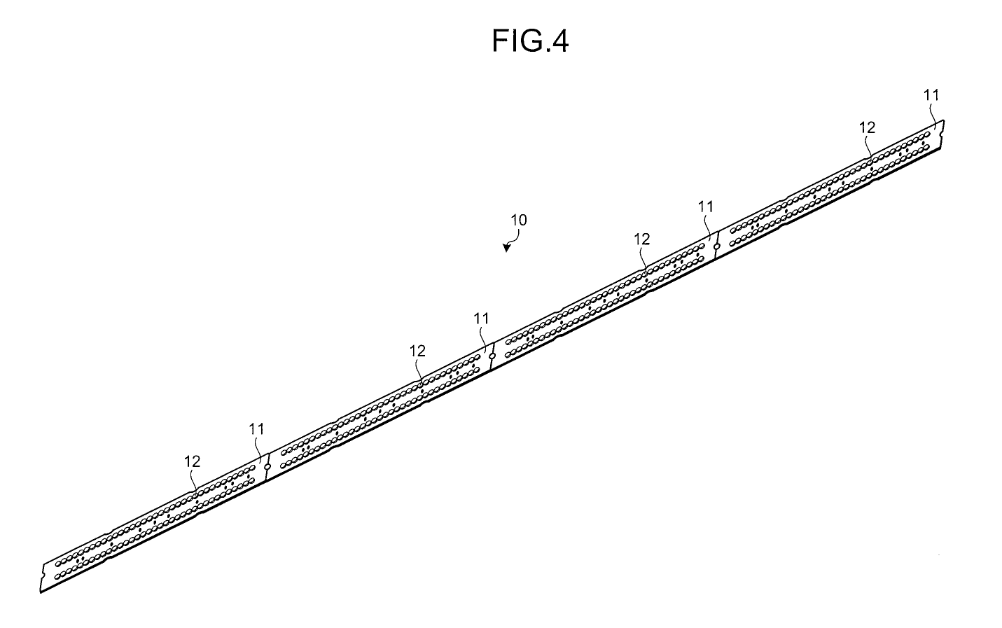

The light-emitting module 10 is provided in the space formed by the lower surface cover 7 and the attachment member 2. FIG. 4 is a diagram of an external appearance example of the light-emitting module. As shown in FIG. 4, the light-emitting module 10 includes a plurality of substrates and the plurality of light-emitting elements 12 respectively mounted on the plurality of substrates 11. The substrates 11 are attached to the attachment member 2. Consequently, the light-emitting module 10 is attached to the attachment member 2.

The light-emitting elements 12 are, for example, LEDs and emit lights. A part of the lights emitted by the light-emitting elements 12 are diffused by the diffuser 9, transmitted through the lower surface cover 7, and travel to the floor of the room. A part of the lights emitted by the light-emitting elements 12 is directly transmitted through the side surface covers 6 and the side surface sections 7a or reflected or diffused by the diffuser 9 and transmitted through the side surface covers 6 and the side surface sections 7a, refracted by the prisms 7b, and travels to the ceiling. Not all of the lights made incident on the prisms 7b travel to the ceiling. Some of the lights made incident on the prisms 7b travel to lateral directions.

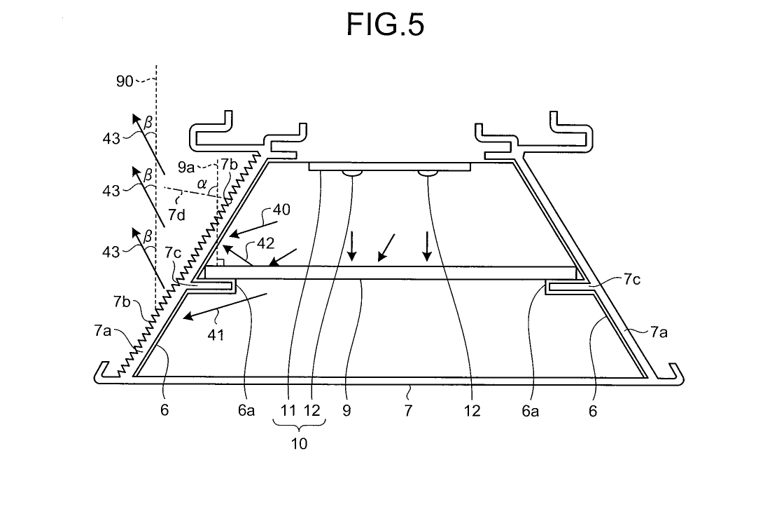

The prisms 7b are explained. FIG. 5 is a sectional view of a portion covered with the lower surface cover 7 on the left side in FIG. 1. The prisms 7b included in the portion covered with the lower surface cover 7 on the left side in FIG. 1 are explained with reference to FIG. 5. The prisms 7b included in a portion covered with the lower surface cover 7 on the right side in FIG. 1 are the same as the prisms 7b shown in FIG. 5. Therefore, explanation of the prisms 7b included in the portion covered with the lower surface cover 7 on the right side in FIG. 1 is omitted.

As shown in FIG. 5, when the luminaire 1 is attached to the ceiling, the prisms 7b adjust the traveling directions of the lights transmitted through the side surface covers 6 and the side surface sections 7a such that lights 43 are irradiated on the ceiling in traveling directions at an angle of β with respect to a direction 90 perpendicular to the ceiling. β is, for example, a value equal to or larger than 40 degrees and equal to or smaller than 90 degrees. However, β is not limited to the value. As explained above, the lights transmitted through the side surface covers 6 and the side surface sections 7a are, for example, lights 40 directly made incident on the side surface covers 6 from the light-emitting elements 12, lights 41 diffused by the diffuser 9, and lights 42 reflected by the diffuser 9.

As shown in FIG. 5, in the luminaire 1 in this embodiment, the cross section of the prism 7b is substantially triangular. An angle α formed by a direction 7d indicated by one side of the substantial triangle indicated by the cross section of the prism 7b and a direction 9a perpendicular to the planar shape of the diffuser 9 may be any value as long as the lights from the prisms 7b can irradiate the ceiling. As shown in FIG. 5, a refractive index of the prisms 7b with respect to the lights emitted from the light-emitting elements 12 is, for example, equal to or larger than 1.45 and equal to or smaller than 1.65. The luminaire 1 is designed such that the ceiling and the diffuser 9 are substantially parallel to each other when the luminaire 1 is attached to the ceiling. Therefore, when the luminaire 1 is attached to the ceiling, the direction 90 and the direction 9a are substantially parallel to each other.

In the luminaire 1 in this embodiment, the diffuser 9 having transmittance for setting a ratio of an amount of the lights transmitted through the lower surface cover 7 and an amount of the lights adjusted by the prisms 7b and irradiated on the ceiling to a ratio in a range of 1:9 to 2:8 is used. In addition, in the luminaire 1 in this embodiment, the diffuser 9 is provided in a position where such a ratio is obtained.

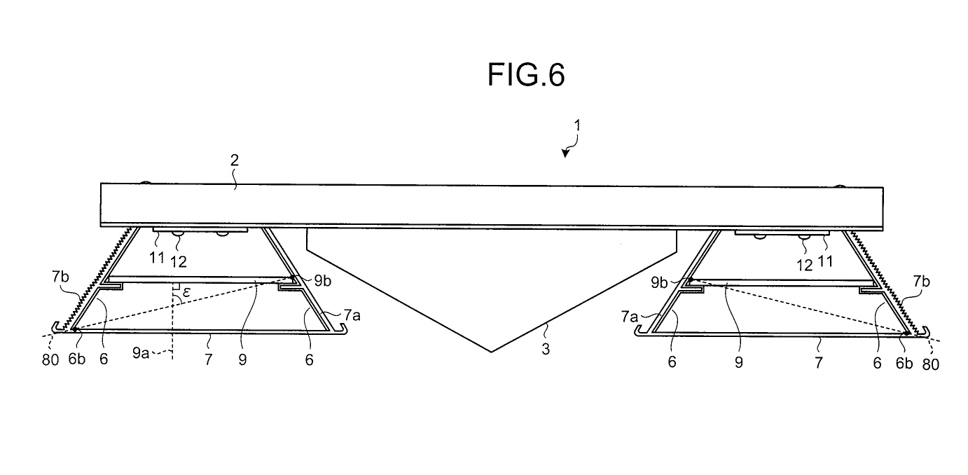

An example of a positional relation between the diffuser 9 and the lower surface cover 7 is explained. FIG. 6 is a diagram showing an example of the positional relation between the diffuser 9 and the lower surface cover 7. FIG. 6 is a sectional view of the luminaire 1. As indicated by an example shown in FIG. 6, an angle ε formed by the straight line 80, which connects the lower end 6b of the side surface cover 6 on which the prisms 7b are provided and the point 9b, and the direction 9a perpendicular to the planar shape of the diffuser 9 is an angle equal to or larger than 5 degrees and equal to or smaller than 30 degrees. The point 9b is a point on the diffuser 9 most distant from the lower end 6b on a cross section including the lower end 6b. That is, the point 9b is a point on the diffuser 9 most distant from the lower end 6b on a plane including the lower end 6b.

### Effects of the Embodiment

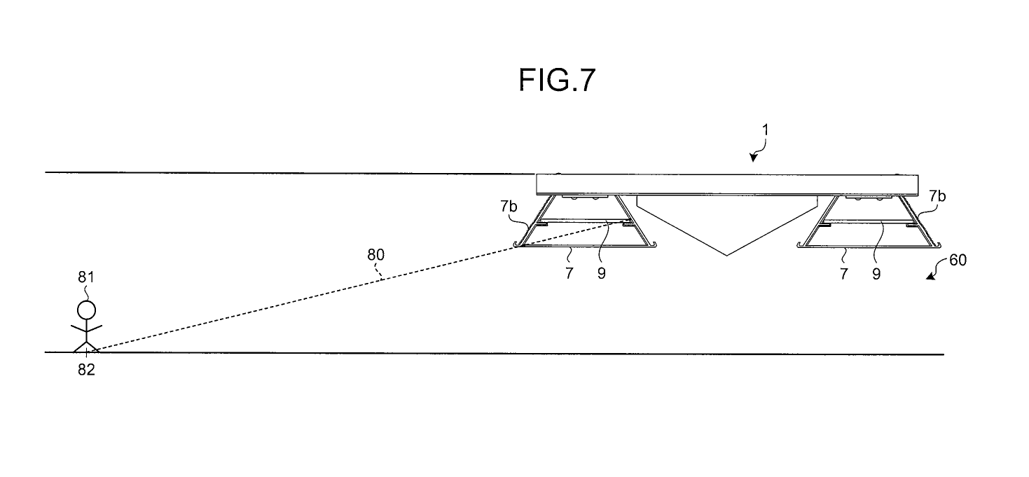

As explained above, the luminaire 1 according to the embodiment includes the light-emitting elements 12, the side surface covers 6, the lower surface cover 7, the diffuser 9, and the prisms 7b, which are an example of optical members. The light-emitting elements 12 emit lights. The side surface covers 6 are arranged at the predetermined distance from the light-emitting elements 12. The light emitted by the light-emitting element 12 is transmitted through the side surface cover 6. The lower surface cover 7 is provided at the lower ends of the side surface covers 6. The light emitted by the light-emitting element 12 is transmitted through the lower surface cover 7. The diffuser 9 is a member provided between the lower surface cover 7 and the light-emitting elements 12 to diffuse the lights emitted by the light-emitting element. The prisms 7b adjust traveling directions of the lights transmitted through the side surface covers 6 to be different from traveling directions of the lights emitted by the light-emitting elements 12 and transmitted through the lower surface cover 7. In this way, in the luminaire 1, the diffuser 9 is provided further on the upper side than the lower surface cover 7. Therefore, as shown in FIG. 7, light from the luminaire 1 is not glaring for a person 81 present in a position 82 further on the outer side of the luminaire 1 than the direction 80 in a room 60. Therefore, with the luminaire 1 according to this embodiment, it is possible to suppress glare. With the luminaire 1 according to this embodiment, the lights transmitted through the side surface covers 6 travel in the directions different from the traveling directions of the lights emitted by the light-emitting elements 12 and transmitted through the lower surface cover 7. Therefore, with the luminaire 1 according to this embodiment, it is possible to improve a sense of brightness of a space and provide a comfortable lighting space for a person. Therefore, with the luminaire 1 according to this embodiment, it is possible to suppress glare and improve the sense of brightness.

In an example shown in FIG. 7, the lights travel in the lateral direction from the prisms 7b. Therefore, the person 81 can view slight lights from the prisms 7b. Thereafter, when the person 81 moves to a position 83 further on the luminaire 1 side than the direction 80 as shown in FIG. 9, the person 81 can view the lights diffused by the diffuser 9. However, the person 81 already views the slight lights from the prisms 7b in the position 82. Therefore, even when the person 81 moves to the position 83, the person 81 hardly has a sense of discomfort to the lights from the diffuser 9. Therefore, with the luminaire 1 according to this embodiment, it is possible to suppress a sense of discomfort to the lights from the luminaire 1.

In the luminaire 1 according to this embodiment, the angle ε formed by the straight line 80, which connects the lower end 6b of the side surface cover 6 and the point 9b on the diffuser 9 most distant from the lower end 6b of the side surface cover 6, and the direction 9a perpendicular to the planar shape of the diffuser 9 is an angle equal to or larger than 5 degrees and equal to or smaller than 30 degrees.

In the luminaire 1 according to this embodiment, the lights diffused or reflected by the diffuser 9 are transmitted through the side surface cover 6.

The luminaire 1 according to this embodiment includes the attachment member 2 for attaching the luminaire 1 to the ceiling. In the luminaire 1, the prisms 7b adjust the traveling directions of the lights transmitted through the side surface covers 6 such that the lights transmitted through the side surface covers 6 are irradiated on the ceiling. Therefore, with the luminaire 1 according to this embodiment, the lights are irradiated on the ceiling as well. Therefore, with the luminaire 1 according to this embodiment, it is possible to improve a sense of brightness of a space and provide a comfortable lighting space for a person.

In the luminaire 1 according to this embodiment, the prisms 7b adjust the traveling directions of the lights transmitted through the side surface covers 6 such that the lights are irradiated on the ceiling in the traveling directions at an angle equal to or larger than 40 degrees and equal to or smaller than 90 degrees with respect to the direction perpendicular to the ceiling.

In the luminaire 1 according to this embodiment, the refractive index of the prisms 7b is equal to or larger than 1.49 and equal to or smaller than 1.59.

In the luminaire 1 according to this embodiment, a ratio of an amount of the lights transmitted through the lower surface cover 7 and an amount of the lights refracted by the prisms 7b and irradiated on the ceiling is in a range of 1:9 to 2:8. Therefore, with the luminaire 1, it is possible to appropriately set an amount of the lights in the floor surface direction and an amount of the lights in the ceiling direction.

In the luminaire 1 according to this embodiment, the hollows 6a are formed in a part of the side surface covers 6. In the luminaire 1, protrusions on the prism 7b is configured to fit in the hollows by which the prisms 7b to be attached to the side surface covers 6. Therefore, with the luminaire 1, it is possible to easily attach the side surface cover 6 to the prism 7b.

In the luminaire 1 according to this embodiment, the lower surface cover 7 and the prisms 7b are integrally molded. Consequently, the lower surface cover 7 and the prisms 7b can be provided as one component. Therefore, it is possible to reduce the number of components.

In the luminaire 1 according to this embodiment, the side surface covers 6 and the prisms 7b may be integrally molded. Consequently, the side surface covers 6 and the prisms 7b can be provided as one component. Therefore, it is possible to reduce the number of components.

In the luminaire 1 according to this embodiment, the side surface covers 6, the lower surface cover 7, and the prisms 7b may be integrally molded. Consequently, the side surface covers 6, the lower surface cover 7, and the prisms 7b can be provided as one component. Therefore, it is possible to reduce the number of components.

In the luminaire 1 according to this embodiment, the side surface covers 6, the lower surface cover 7, the prisms 7b, and the diffuser 9 may be integrally molded. Consequently, the side surface covers 6, the lower surface cover 7, the prisms 7b, and the diffuser 9 can be provided as one component. Therefore, it is possible to reduce the number of components.

In the luminaire 1 according to this embodiment, the prisms 7b are provided on the side surface covers 6 that is located on the outermost side among the plurality of side surface covers 6. Consequently, the prisms 7b are provided only on the side surface covers 6 present in positions where lights can be irradiated on the ceiling. Therefore, the number of the prisms 7b used for making the ceiling bright can be minimized.

In the luminaire 1 according to this embodiment, the prisms 7b may be provided in each of the plurality of side surface covers 6. Consequently, for example, the prisms 7b are provided not only on the side surface covers 6 present in the positions where lights can be irradiated on the ceiling but also on the side surface covers 6 present in positions where lights can be irradiated on the reflector 3. Therefore, it is possible to increase an amount of lights reflected by the reflector 3. Therefore, it is possible to further improve a sense of brightness of a space and provide a more comfortable lighting space for a person.

In the luminaire 1 according to this embodiment, the prisms 7b are formed of a material containing acrylic resin or polycarbonate resin.

The shapes, the materials, and the material properties of the members according to the embodiment are not limited to the examples explained and shown in the embodiment and the figures.

As explained above, according to the embodiment, it is possible to suppress glare.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

What is claimed is:

1. A luminaire comprising:
a light-emitting element configured to emit light;
a side surface cover arranged a predetermined distance from the light-emitting element and through which the light emitted by the light-emitting element is transmitted;
a lower surface cover provided at a lower end of the side surface cover and through which the light emitted by the light-emitting element is transmitted;
a diffuser provided between the lower surface cover and the light-emitting element to diffuse the light emitted by the light-emitting element; and
an optical member configured to adjust a traveling direction of the light transmitted through the side surface cover to be different from a traveling direction of the light emitted by the light-emitting element and transmitted through the lower surface cover.

2. The luminaire according to claim 1, wherein an angle formed by a straight line, which connects a lower end of the side surface cover and a point on the diffuser most distant from the lower end of the side surface cover, and a direction perpendicular to a planar shape of the diffuser is an angle equal to or larger than 5 degrees and equal to or smaller than 30 degrees.

3. The luminaire according to claim 1, wherein the light diffused or reflected by the diffuser is transmitted through the side surface cover.

4. The luminaire according to claim 3, further comprising an attachment member for attaching the luminaire to a ceiling, wherein
the optical member adjusts the traveling direction of the light transmitted through the side surface cover such that the light transmitted through the side surface cover is irradiated on the ceiling.

5. The luminaire according to claim 4, wherein the optical member adjusts the traveling direction of the light transmitted through the side surface cover such that the light is irradiated on the ceiling in a traveling direction at an angle equal to or larger than 40 degrees and equal to or smaller than 90 degrees with respect to a direction perpendicular to the ceiling.

6. The luminaire according to claim 1, wherein a refractive index of the optical member is equal to or larger than 1.45 and equal to or smaller than 1.65.

7. The luminaire according to claim 1, wherein a ratio of an amount of the light transmitted through the lower surface cover and an amount of the light adjusted by the optical member is in a range of 1:9 to 2:8.

8. The luminaire according to claim 1, wherein
a hollow is formed in a part of the side surface cover, and
a protrusion on the optical member configured to fit in the hollow by which the optical member is to be attached to the side surface cover.

9. The luminaire according to claim 1, wherein the lower surface cover and the optical member are integrally molded.

10. The luminaire according to claim 1, wherein the side surface cover and the optical member are integrally molded.

11. The luminaire according to claim 1, wherein the side surface cover, the lower surface cover, and the optical member are integrally molded.

12. The luminaire according to claim 1, wherein
the lower surface cover includes a side surface section configured to cover the side surface cover, and
the lower surface cover, the side surface section, the optical member, the side surface cover, and the diffuser are integrally molded.

13. The luminaire according to claim 1, wherein
the luminaire includes a plurality of the side surface covers, and
the optical member is provided on the side surface cover that is located on an outermost side among the plurality of side surface covers.

14. The luminaire according to claim 1, wherein
the luminaire includes a plurality of the side surface covers, and
the optical member is provided in each of the plurality of side surface covers.

15. The luminaire according to claim 1, wherein the optical member is formed of a material containing acrylic resin or polycarbonate resin.

16. A luminaire comprising:
a light-emitting element;
a side cover through which light emitted by the light-emitting element is transmitted;
an optical medium arranged on the side cover, the optical medium having a refractive index equal to or larger than 1.45 and equal to or smaller than 1.65 and through which the light transmitted through the side cover travels.

17. The luminaire according to claim 16, further comprising:
a bottom cover; and
a diffuser between the light-emitting element and the bottom cover,
wherein the light diffused or reflected by the diffuser is transmitted through the side surface cover.

18. The luminaire according to claim 17, wherein the side cover has a hollow portion formed on an outer periphery thereof, and the optical medium includes a protrusion configured to fit in the hollow by which the optical medium can be attached to the side cover.

19. The luminaire according to claim 17, wherein a ratio of an amount of the light transmitted through the bottom cover and an amount of the light adjusted by the optical medium is in a range of 1:9 to 2:8.

20. The luminaire according to claim 17, wherein an angle formed by a straight line, which connects a lower end of the side cover and a point on the diffuser most distant from the lower end of the side cover, and a direction perpendicular to a plane of the diffuser is an angle equal to or larger than 5 degrees and equal to or smaller than 30 degrees.
